(19) United States
(12) Patent Application Publication
(10) Pub. No.: US 2026/0221095 A1
(43) Pub. Date: Jul. 30, 2026

(54) ORGANIC LIGHT EMITTING DISPLAY APPARATUS AND DRIVING METHOD THEREOF

(71) Applicant: LG Display Co., Ltd., Seoul (KR)

(72) Inventors: Soek Min CHOI, Paju-si (KR); Moo Kyoung HONG, Paju-si (KR)

(73) Assignee: LG Display Co., Ltd., Seoul (KR)

(21) Appl. No.: 19/439,719

(22) Filed: Jan. 5, 2026

(30) Foreign Application Priority Data
Jan. 24, 2025 (KR) 10-2025-0011698

(51) Int. Cl. G09G 3/3233

(52) U.S. Cl. CPC G09G 3/3233; G09G 2300/0819; G09G 2310/021; G09G 2310/08; G09G 2320/0223; G09G 2320/0233

(57) ABSTRACT

An organic light emitting display apparatus includes a display panel including a plurality of subpixels, the plurality of subpixels being scanned based on a scan signal of one scan mode among a plurality of frequency variable scan modes, a sensing circuit configured to sense off change timings of a scan signal for each scan mode and panel position in a first sensing sequence and sense a ripple voltage added to an initialization voltage of each of the plurality of subpixels at the off change timings of the scan signal during a second sensing sequence independent of the first sensing sequence, and a correction circuit configured to correct a data voltage which is to be input to each subpixel, based on a compensation gain for compensating for a luminance variation caused by the ripple voltage.

### CROSS-REFERENCE TO RELATED APPLICATIONS

This application claims the benefit of and priority to Korean Patent Application No. 10-2025-0011698 filed on Jan. 24, 2025, the entire contents of which are incorporated herein by reference for all purposes.

### BACKGROUND

### 1. Technical Field

The present disclosure relates to an organic light emitting display apparatus and a driving method thereof.

### 2. Description of Related Art

Organic light emitting display apparatuses support a plurality of frequency variable scan modes so as to satisfy various needs of consumers. The frequency variable scan modes include a dynamic frequency & resolution (DFR) scan mode and a scan mode of various frequencies, which are predetermined.

Organic light emitting display apparatuses may change a scan mode in the middle of driving. A 240 Hz scan mode, a 60 Hz scan mode, and a 480 Hz DFR scan mode differ in scan overlap characteristic. Due to a scan overlap characteristic difference, an initialization level of a source voltage of a driving transistor may vary depending on a scan mode in data programming, and as a result, a luminance deviation may occur when changing a scan mode. A level of a luminance deviation is affected by the degree of RC delay, and thus, is changed depending on a panel position. A level of a luminance deviation is greater at a panel position, where a gate load is relatively large, than a panel position where a gate load is relatively small. Display quality is degraded by a panel position-based luminance deviation which occurs at different levels when changing a scan mode.

The description of related art should not be considered prior art merely because it is mentioned in or associated with this section. The description of related art includes information that describes one or more aspects of the subject technology, and the description in this section does not limit the scope of the present disclosure.

### SUMMARY

To overcome the aforementioned problem of the related art, the present disclosure may provide an organic light emitting display apparatus and a driving method thereof, which may compensate for a panel position-based luminance deviation occurring at different levels for each scan mode.

To achieve these aspects and other advantages and in accordance with the purpose of the disclosure, as embodied and broadly described herein, an organic light emitting display apparatus includes: a display panel including a plurality of subpixels, the plurality of subpixels being scanned based on a scan signal of one scan mode among a plurality of frequency variable scan modes; a sensing circuit configured to sense off change timings of a scan signal for each scan mode and panel position in a first sensing sequence and sense a ripple voltage added to an initialization voltage of each of the plurality of subpixels at the off change timings of the scan signal during a second sensing sequence independent of the first sensing sequence; and a correction circuit configured to correct a data voltage which is to be input to each subpixel, based on a compensation gain for compensating for a luminance variation caused by the ripple voltage.

Additional features, advantages, and aspects of the present disclosure are set forth in part in the description that follows and in part will become apparent from the present disclosure or may be learned by practice of the inventive concepts provided herein. Other features, advantages, and aspects of the present disclosure may be realized and attained by the descriptions provided in the present disclosure, or derivable therefrom, and the claims hereof as well as the drawings. It is intended that all such features, advantages, and aspects be included within this description, be within the scope of the present disclosure, and be protected by the following claims. Nothing in this section should be taken as a limitation on those claims. Further features, advantages, and aspects are discussed below in conjunction with embodiments of the present disclosure.

It is to be understood that both the foregoing description and the following description of the present disclosure are examples, and are intended to provide further explanation of the disclosure as claimed.

### BRIEF DESCRIPTION OF THE DRAWINGS

The accompanying drawings, which are included to provide a further understanding of the present disclosure, are incorporated in and constitute a part of this present disclosure, illustrate aspects and embodiments of the present disclosure, and together with the description serve to explain principles and examples of the disclosure. In the drawings:

FIG. 1 is a block diagram illustrating an organic light emitting display apparatus according to an embodiment of the present disclosure;

FIG. 2 is a diagram illustrating a connection configuration of a pixel according to an embodiment of the present disclosure;

FIG. 3 is a diagram illustrating an initialization level of a source voltage of a driving transistor in data programming in a 240 Hz scan mode;

FIG. 4 is a diagram illustrating an initialization level of a source voltage of a driving transistor in data programming in a 60 Hz scan mode;

FIG. 5 is a diagram illustrating an initialization level of a source voltage of a driving transistor in data programming in a 480 Hz DFR scan mode;

FIG. 6 is a diagram illustrating an example where a ripple voltage caused by a discharge operation of a subpixel affects a source voltage of an adjacent subpixel in scan overlap driving;

FIG. 7 is a diagram illustrating an example where a source voltage of a subpixel is distorted due to a ripple voltage added to an initialization voltage at an off change timing of a scan signal which is a Vgs setting timing, in scan overlap driving;

FIG. 8 is a diagram illustrating an example where the degree of RC delay of a scan signal varies based on a panel position;

FIG. 9 is a diagram illustrating an output waveform of a scan signal with respect to an point relatively close to and a B point relatively far away from an input position of the scan signal;

FIG. 10 is a diagram illustrating a connection configuration between a sensing circuit, correction circuit, and a memory according to an embodiment of the present disclosure;

FIG. 11 is a diagram illustrating an operation sequence of a first sensing sequence for sensing off change timings of a scan signal for each scan mode and panel position;

FIG. 12 is a diagram illustrating an operation sequence of a second sensing sequence for sensing a ripple voltage added to an initialization voltage of each subpixel at off change timings of a scan signal;

FIGS. 13 to 15 are diagrams for describing operations of a subpixel and a sensing circuit in a first sensing sequence;

FIGS. 16 and 17 are diagrams for describing operations of a subpixel and a sensing circuit in a second sensing sequence;

FIG. 18 is a diagram for describing the principle that a ripple voltage added to an initialization voltage may be sensed in display driving;

FIG. 19 is a diagram illustrating a level of a ripple voltage with respect to luminance and each scan mode; and

FIG. 20 is a diagram illustrating a magnitude of a compensation gain with respect to luminance and each scan mode.

Throughout the drawings and the detailed description, unless otherwise described, the same drawing reference numerals should be understood to refer to the same elements, features, and structures. The sizes, lengths, and thicknesses of layers, regions and elements, and depiction thereof may be exaggerated for clarity, illustration, and/or convenience.

### DETAILED DESCRIPTION

Hereinafter, the present disclosure will be described more fully with reference to the accompanying drawings, in which example embodiments of the disclosure are shown. The disclosure may, however, be embodied in many different forms and should not be construed as being limited to the embodiments set forth herein; rather, these embodiments are provided so that this disclosure will be thorough and complete, and will fully convey the concept of the disclosure to those skilled in the art.

Advantages and features of the present disclosure, and implementation methods thereof will be clarified through following embodiments described with reference to the accompanying drawings. The present disclosure may, however, be embodied in different forms and should not be construed as limited to the embodiments set forth herein. Rather, these embodiments are provided so that this disclosure will be thorough and complete, and will fully convey the scope of the present disclosure to those skilled in the art. Furthermore, the present disclosure is only defined by scopes of claims.

The shapes, sizes, ratios, angles, numbers and the like disclosed in the drawings for description of various embodiments of the present disclosure to describe embodiments of the present disclosure are merely examples and the present disclosure is not limited thereto. Like reference numerals refer to like elements throughout. Throughout this specification, the same elements are denoted by the same reference numerals. As used herein, the terms “comprise”, “having”, “including” and the like suggest that other parts can be added unless the term “only” is used. As used herein, the singular forms “a”, “an”, and “the” are intended to include the plural forms as well, unless context clearly indicates otherwise. In one or more examples, unless expressly stated otherwise, an element may be one or more elements; and an element may include a plurality of elements.

Elements in various embodiments of the present disclosure are to be interpreted as including margins of error even without explicit statements.

In describing a position relationship, for example, when a position relation between two parts is described as “on~”, “over~”, “under~”, and “next~”, one or more other parts may be disposed between the two parts unless “just” or “direct” is used.

It will be understood that, although the terms “first”, “second”, etc. may be used herein to describe various elements, these elements should not be limited by these terms. These terms are merely used to refer to one element separately from another. For example, a first element could be termed a second element, and, similarly, a second element could be termed a first element, without departing from the scope of the present disclosure.

In the following description, when the detailed description of the relevant known function or configuration is determined to unnecessarily obscure the important point of the present disclosure, the detailed description will be omitted. Hereinafter, embodiments of the present disclosure will be described in detail with reference to the accompanying drawings.

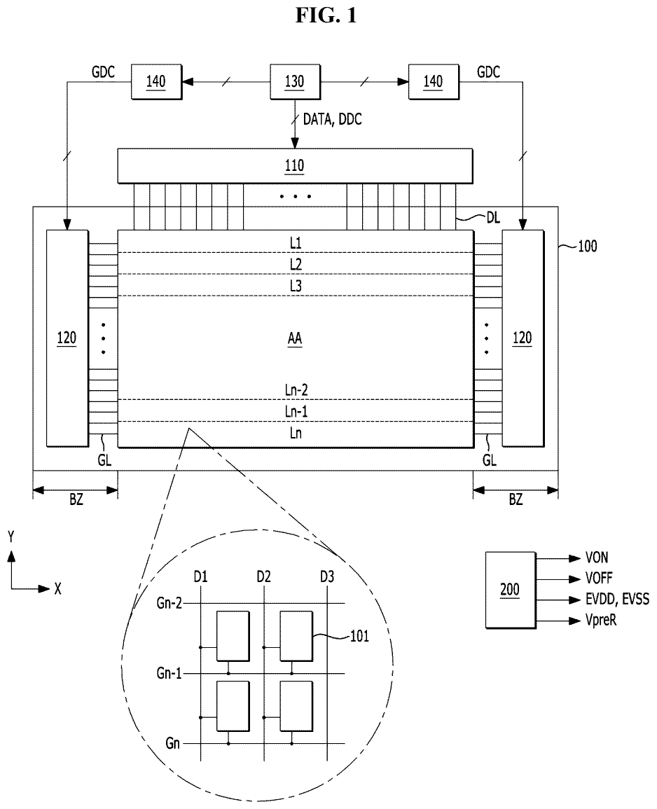

FIG. 1 is a block diagram illustrating an organic light emitting display apparatus according to an embodiment of the present disclosure.

Referring to FIG. 1, a display panel 100 may include a screen AA which displays an input image. The screen AA may include a pixel array which displays pixel data (hereinafter referred to as “image data”) DATA of an input image. The pixel array may include a plurality of data lines DL, a plurality of gate lines GL intersecting with the data lines DL, a plurality of reference voltage lines, and a plurality of pixels.

The pixels may be arranged in the screen AA in a matrix type defined by the data lines DL, the gate lines GL, and the reference voltage lines. The pixels may be arranged as various types, such as a stripe type and a diamond type as well as a matrix type, on the screen AA.

The pixel array may include a plurality of pixel columns and a plurality of pixel lines L1 to Ln intersecting with the pixel columns. Each of the pixel columns may include pixels which are arranged in a Y-axis direction. A pixel line may include pixels which are arranged in an X-axis direction. One vertical period may be one frame period needed for writing image data DATA of one frame in all pixels of the screen. One horizontal period may be a time obtained by dividing one frame period by the number of pixel lines L1 to Ln. One horizontal period may be a time needed for writing the image data DATA of one pixel row, sharing a gate line GL, in pixels of one pixel row.

Each of the pixels may include a red (R) subpixel 101, a green (G) subpixel 101, a blue (B) subpixel 101, and a white (W) subpixel 101 for implementing colors.

The display apparatus according to the present embodiment may be implemented as an organic light emitting display apparatus. In this case, a pixel circuit of the frequency variable display apparatus may include a light emitting device, a driving element, one or more switch elements, and a capacitor. The light emitting device may be implemented as an organic light emitting diode (OLED). A driving current which allows the light emitting device to emit light may be adjusted based on a gate-source voltage of the driving element. Each of the driving element and the switch element may be implemented as a transistor. A semiconductor layer of the transistor may include amorphous silicon or polysilicon. Semiconductor layers of at least some of transistors may include oxide. The pixel circuit may be connected to a data line DL and a gate line GL. In FIG. 1, “D1 to D3” illustrated in a circle may be data lines, and “Gn-2 to Gn” may be gate lines.

Touch sensors may be disposed in the display panel 100. The touch sensors may be arranged as an on-cell or add-on type on the screen AA of the display panel 100, or may be implemented as in-cell type touch sensors embedded in the pixel array. A touch input may be sensed through the touch sensors, or may be sensed through only pixels even without touch sensors.

A source driver 110 may convert the image data DATA, received from a timing controller 130, into gamma compensation voltages by using a digital-to-analog converter (DAC) to generate data voltages. The source driver 110 may supply the data voltages to the data lines DL. The data voltages may be supplied to the data lines DL and may be applied to gate electrodes of the driving elements through the switch elements of the subpixels 101. The source driver 110 may supply an initialization voltage VpreR, received from a power circuit 200, to reference voltage lines connected to the subpixels. The initialization voltage VpreR may be supplied to the reference voltage lines and may be applied to a source electrode of the driving element through a switch element of each subpixel 101.

The source driver 110 may be implemented with one or more source drive integrated circuits (ICs). The source drive IC may be connected to the timing controller 130 through an internal interface circuit. The internal interface circuit may be implemented as an embedded clock point to point interface (EPI). The source drive IC may further include a touch driver. The touch driver may generate a touch sensor driving signal and may convert an electric charge variation of a touch sensor into touch raw data. The touch driver may transfer the touch raw data to a host system (not shown) through a separate interface circuit. The separate interface circuit may be implemented as a serial peripheral interface (SPI).

A gate driver 120 may be provided in a bezel area BZ disposed outside the screen AA in the display panel 100. The bezel area BZ may not display an image. The gate driver 120 may sequentially supply a gate signal, synchronized with data voltages, to the gate lines GL according to control by the timing controller 130. The gate signal may simultaneously activate pixels of the same pixel row into which a data voltage is charged. The gate driver 120 may output the gate signal by using one or more shift registers and may shift the gate signal. The gate signal may be referred to as a scan signal. The scan signal may include a gate on voltage VON and a gate off voltage VOFF, which are received from the power circuit 200.

The gate driver 120 may perform on scan overlap driving. Scan on periods of adjacent scan signals may partially overlap each other, based on the scan overlap driving. A data programming operation (i.e., a gate-source voltage (hereinafter referred to as Vgs) setting operation of the driving transistor) may be performed in a scan on period of the scan signal in subpixels of each pixel row. The scan overlap driving may increase the scan on period when a frame frequency is high, and thus, may enable stable Vgs setting.

The gate driver 120 may support a plurality of frequency variable scan modes and may change a scan mode in the middle of display driving, based on control by the timing controller 130. The plurality of frequency variable scan modes may further include a dynamic frequency & resolution (DFR) scan mode in addition to a normal scan mode such as a 240 Hz scan mode or a 60 Hz scan mode.

In the DFR scan mode, a scan signal pair of the same phase may be supplied to two gate lines disposed adjacent to each other. That is, in the DFR scan mode, gate lines paired in twos may be sequentially scanned by scan signal pairs where phases are sequentially shifted. Comparing with the normal scan mode, a vertical resolution of a screen image may decrease by half in the DFR scan mode.

Due to an overlap characteristic difference for each scan mode, an initialization level of a source voltage of the driving transistor may vary based on a scan mode in data programming, and thus, a luminance deviation may occur when changing a scan mode. A level of such a luminance deviation may be affected by the degree of RC delay of a scan signal, and thus, may be changed based on a panel position.

To compensate for a panel position-based luminance deviation occurring at different levels for each scan mode, the organic light emitting display apparatus according to the present embodiment may include a sensing circuit and a correction circuit in the source driver 110.

The sensing circuit may be provided in plurality in the source driver 110. The sensing circuit may sense off change timings of a scan signal with respect to each scan mode and panel position in a first sensing sequence and may sense a ripple voltage added to an initialization voltage of each subpixel in the off change timings of the scan signal in a second sensing sequence.

The correction circuit may correct a data voltage which is to be input to each subpixel, based on a compensation gain for compensating for a luminance variation caused by the ripple voltage. The correction circuit may be included in the timing controller 130.

The timing controller 130 may receive video data DATA and a timing signal, synchronized with the video data DATA, from the host system (not shown). The timing signal may include a vertical synchronization signal Vsync, a horizontal synchronization signal Hsync, a clock signal DCLK, and a data enable signal DE. The vertical synchronization signal Vsync may define a vertical period (i.e., one frame). The horizontal synchronization signal Hsync may define a horizontal period. The data enable signal DE may define a time (i.e., a vertical active period) where data voltages are input to subpixels in a vertical period. The other time, except the vertical active period, of the vertical period may be a vertical blank period. The data enable signal DE may swing in the vertical active period and may not swing in the vertical blank period.

The timing controller 130 may generate a source timing control signal DDC for controlling an operation timing of the source driver 110 and a gate timing control signal GDC for controlling an operation timing of the gate driver 120, based on the timing signal Vsync, Hsync, and DE received from the host system.

The host system may be one of a television (TV), a set-top box, a navigation system, a personal computer (PC), a home theater, an automotive display system, a mobile device, and a wearable device. In the mobile device and the wearable device, the source driver 110, the timing controller 130, and a level shifter 140 may be integrated into one drive IC.

The level shifter 140 may shift a logic voltage level of the gate timing control signal GDC, output from the timing controller 130, to the gate on voltage VON or the gate off voltage VOFF to supply to the gate driver 120. A low logic voltage of the gate timing control signal GDC may be down-shifted to the gate off voltage VOFF, and a high logic voltage of the gate timing control signal GDC may be up-shifted to the gate on voltage VON.

The power circuit 200 may generate various source voltages needed for panel driving. The power circuit 200 may generate the gate on voltage VON and the gate off voltage VOFF needed for generating of the scan signal, generate a high-level source voltage EVDD and a low-level source voltage EVSS which are to be supplied to each subpixel 101, and generate the initialization voltage VpreR which is to be supplied to a reference voltage line.

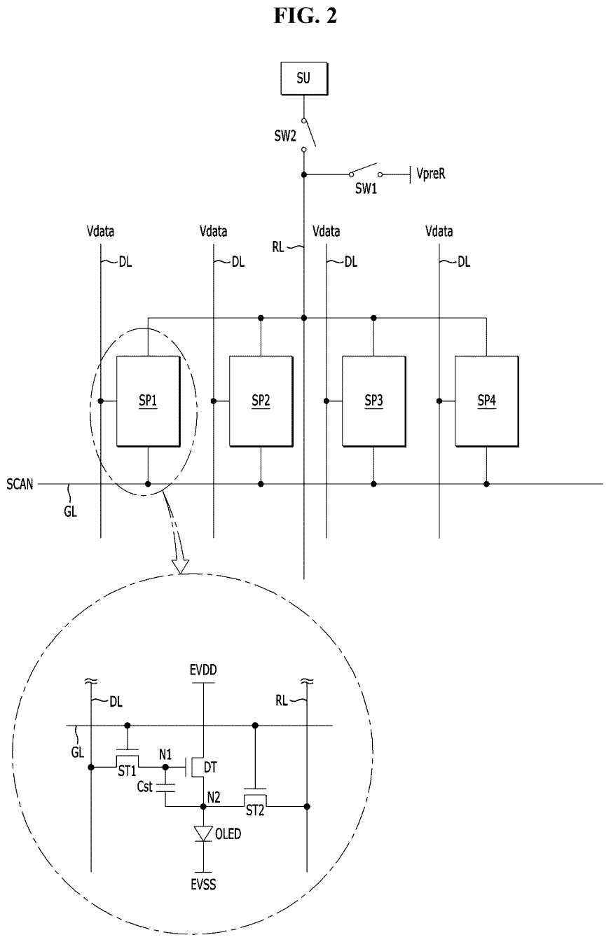

FIG. 2 is a diagram illustrating a connection configuration of a pixel according to an embodiment of the present disclosure.

Referring to FIG. 2, the pixel may include four subpixels SP1 to SP4 which share a reference voltage line RL. The four subpixels SP1 to SP4 may be R, G, B, and W subpixels for configuring the same pixel. Each of the subpixels SP1 to SP4 may include, for example, a light emitting element OLED, a driving transistor DT, first and second switch transistors ST1 and ST2, and a storage capacitor Cst.

The light emitting element OLED may emit light with a driving current supplied from the driving transistor DT to implement luminance. An anode electrode of the light emitting device OLED may be connected to a second node N2, and a cathode electrode thereof may be connected to an input terminal of a low-level source voltage EVSS.

The driving transistor DT may generate a driving current based on a gate-source voltage thereof to supply the driving current to the light emitting element OLED. A gate electrode of the driving transistor DT may be connected to a first node N1, a drain electrode thereof may be connected to an input terminal of a high-level source voltage EVDD, and a source electrode thereof may be connected to the second node N2.

A gate electrode of the first switch transistor ST1 may be connected to a scan gate line GL. A first electrode of the first switch transistor ST1 may be connected to a data line DL, and a second electrode thereof may be connected to the first node N1.

A gate electrode of the second switch transistor ST2 may be connected to a sense gate line GL. A first electrode of the second switch transistor ST2 may be connected to the reference voltage line RL, and a second electrode thereof may be connected to the second node N2.

One electrode of the storage capacitor Cst may be connected to the first node N1, and the other electrode thereof may be connected to the second node N2.

The first and second switch transistors ST1 and ST2 may be turned on based on a scan signal SCAN of a gate on voltage VON in a vertical active period, and thus, may connect the gate electrode of the driving transistor DT to the data line DL and may connect the source electrode of the driving transistor DT to the reference voltage line RL. Accordingly, a data programming operation corresponding to image data may be performed. The data programming operation may be referred to as a gate-source voltage (Vgs) setting operation on the driving transistor DT. The gate-source voltage (Vgs) may be a difference voltage “Vdata−VpreR” between a data voltage Vdata and an initialization voltage VpreR. Although described below, when a ripple voltage based on scan overlap driving is added to the initialization voltage VpreR, the gate-source voltage (Vgs) and luminance based thereon may be distorted. When the data programming operation is completed in the vertical active period, the first and second switch transistors ST1 and ST2 may be turned off based on the scan signal SCAN of a gate off voltage VOFF.

A first switch SW1 and a second switch SW2 may be further connected to the reference voltage line RL. The first switch SW1 may connect an input of the initialization voltage VpreR to the reference voltage line RL. The second switch SW2 may connect a sensing circuit SU to the reference voltage RL during first and second sensing sequences. The first switch SW1 and the second switch SW2 may be included in a source driver along with the sensing circuit SU.

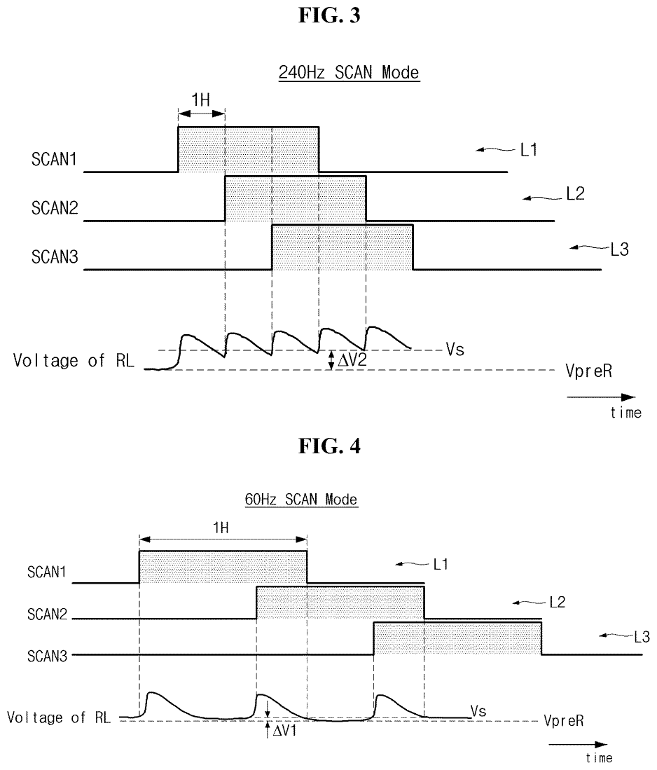

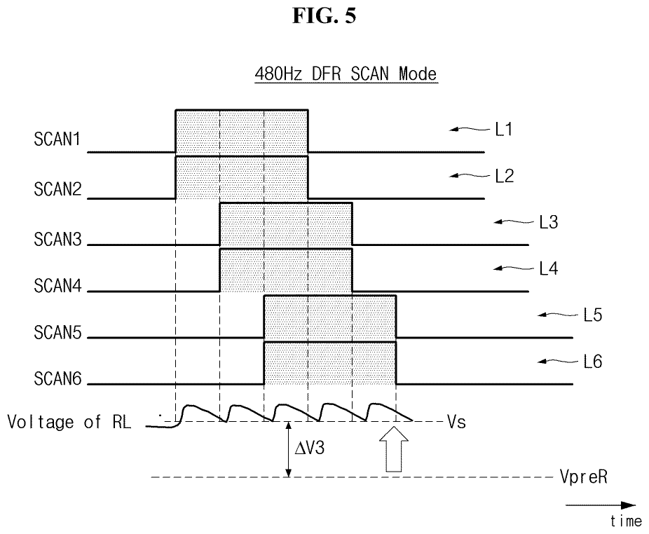

FIG. 3 is a diagram illustrating an initialization level of a source voltage of a driving transistor in data programming in a 240 Hz scan mode. FIG. 4 is a diagram illustrating an initialization level of a source voltage of a driving transistor in data programming in a 60 Hz scan mode. FIG. 5 is a diagram illustrating an initialization level of a source voltage of a driving transistor in data programming in a 480 Hz DFR scan mode.

Referring to FIGS. 3 to 5, the 240 Hz scan mode, the 60 Hz scan mode, and the 480 Hz DFR scan mode may differ in scan overlap characteristic. Due to such overlap characteristic difference, an initialization level of a source voltage Vs of a driving transistor may vary based on a scan mode in data programming.

For example, in the 60 Hz scan mode of FIG. 4, an initialization level of a source voltage Vs for Vgs setting may be ΔV1 higher than an initialization voltage VpreR. In the 240 Hz scan mode of FIG. 3, the initialization level of the source voltage Vs for Vgs setting may be ΔV2 higher than the initialization voltage VpreR. In the 480 Hz DFR scan mode of FIG. 5, the initialization level of the source voltage Vs for Vgs setting may be ΔV3 higher than the initialization voltage VpreR.

In this case, ΔV2 may be greater than ΔV1, and ΔV3 may be greater than ΔV2. An initialization characteristic may be relatively best in the 60 Hz scan mode and may be relatively worst in the 480 Hz DFR scan mode.

Comparing with the 60 Hz scan mode where a length of an overlap time is relatively short, a length of an overlap time may be long in the 240 Hz scan mode and the 480 Hz DFR scan mode, and thus, the 240 Hz scan mode and the 480 Hz DFR scan mode may be much affected by discharging of an adjacent pixel row. In the 240 Hz scan mode and the 480 Hz DFR scan mode, due to a discharging influence of an adjacent pixel row, it may be difficult to sufficiently lower a voltage of a reference voltage line up to the initialization voltage VpreR. Particularly, in the 480 Hz DFR scan mode, subpixels disposed in two adjacent pixel rows may be discharged at a time, and thus, the initialization level of the source voltage Vs for Vgs setting may be worst.

In display driving, in a case where the 240 Hz scan mode is changed to the 60 Hz scan mode, when the same panel position and the same data voltage are assumed, the initialization level of the source voltage Vs may be lowered, and thus, Vgs may increase, thereby increasing luminance.

On the other hand, in display driving, in a case where the 60 Hz scan mode is changed to the 480 Hz DFR scan mode, when the same panel position and the same data voltage are assumed, the initialization level of the source voltage Vs may increase, and thus, Vgs may decrease, thereby decreasing luminance.

A level of a luminance deviation caused by such a scan mode change may be affect by the degree of RC delay of a scan signal, and thus, may vary based on a panel position.

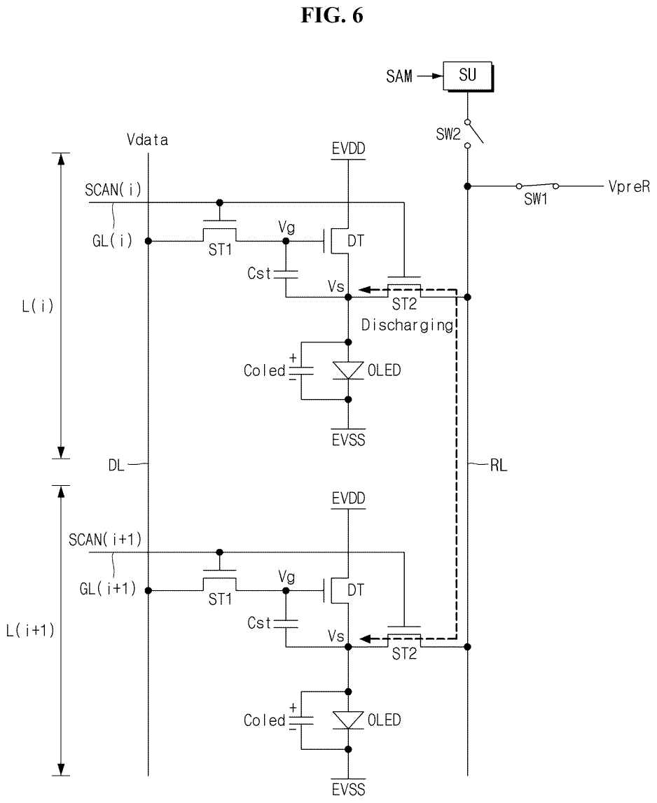

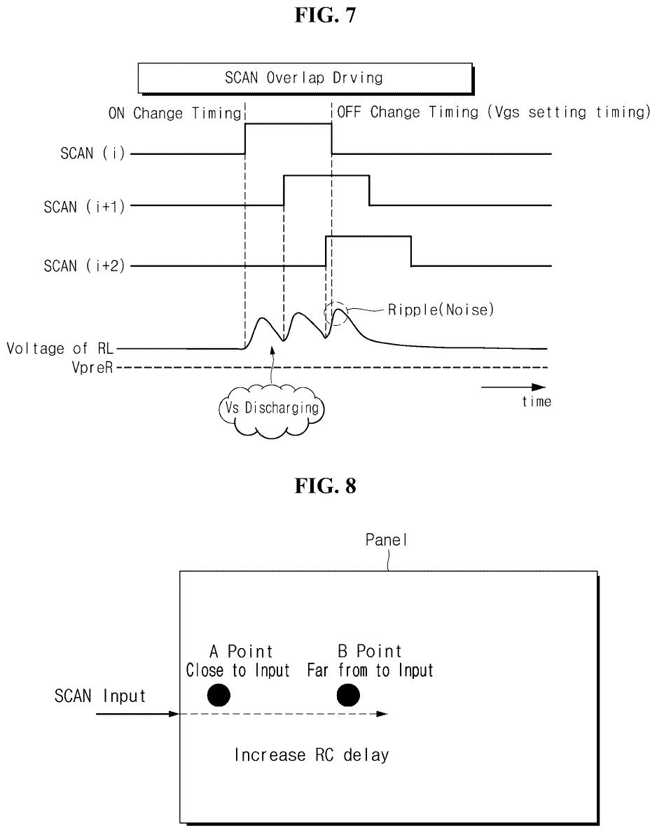

FIG. 6 is a diagram illustrating an example where a ripple voltage caused by a discharge operation of a subpixel affects a source voltage of an adjacent subpixel in scan overlap driving. FIG. 7 is a diagram illustrating an example where a source voltage of a subpixel is distorted due to a ripple voltage added to an initialization voltage at an off change timing of a scan signal which is a Vgs setting timing, in scan overlap driving.

Referring to FIG. 6, based on a discharge operation in scan overlap driving, subpixels disposed in an i^{th} (where i may be a natural number) pixel row Li and subpixels disposed in an i^{th}+1 pixel row Li+1 may be affected therebetween.

For example, a ripple voltage may be added to an initialization voltage VpreR of a reference voltage line RL, based on a discharge operation of the subpixels disposed in the i^{th} pixel row Li and the i^{th}+1 pixel row Li+1. The ripple voltage added to the initialization voltage VpreR may affect a source voltage Vs in Vgs setting of the subpixels disposed in the i^{th} pixel row Li and the i^{th}+1 pixel row Li+1.

Referring to FIG. 7, Vgs setting of each pixel row may be completed at an off change timing of a scan signal SCAN. In other words, the off change timing of the scan signal SCAN may be a determination time of a source voltage Vs reflected in Vgs setting in each pixel row.

A source voltage Vs determination time of the i^{th} pixel row Li may be an off change timing of an i^{th} scan signal SCAN(i), a source voltage Vs determination time of the i^{th}+1 pixel row Li+1 may be an off change timing of an i^{th}+1 scan signal SCAN(i+1), and a source voltage Vs determination time of the i^{th}+2 pixel row Li+2 may be an off change timing of an i^{th}+2 scan signal SCAN(i+2).

Due to a ripple voltage which is added to the initialization voltage VpreR at the off change timing of an i^{th} scan signal SCAN(i), a source voltage Vs of the subpixel disposed in the i^{th}pixel row Li may be distorted. Due to a ripple voltage which is added to the initialization voltage VpreR at the off change timing of an i^{th}+1 scan signal SCAN(i+1), a source voltage Vs of the subpixel disposed in the i^{th}+1 pixel row Li+1 may be distorted. Likewise, due to a ripple voltage which is added to the initialization voltage VpreR at the off change timing of an i^{th}+2 scan signal SCAN(i+2), a source voltage Vs of the subpixel disposed in the i^{th}+2 pixel row Li+2 may be distorted.

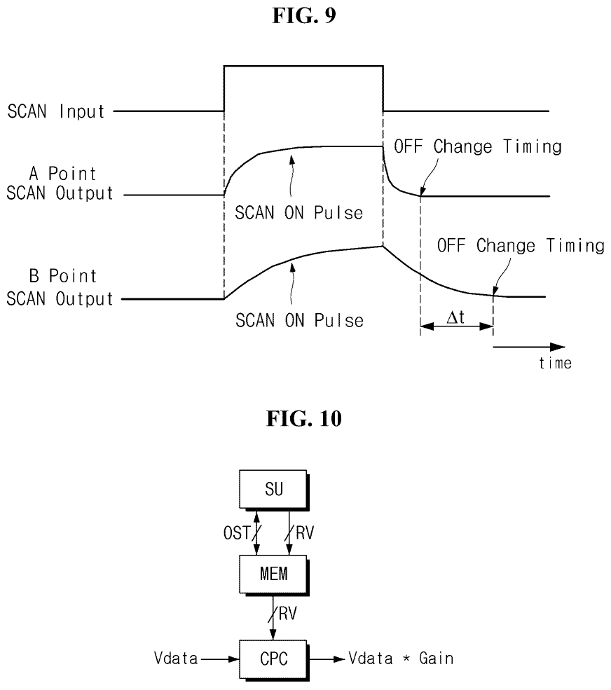

FIG. 8 is a diagram illustrating an example where the degree of RC delay of a scan signal varies based on a panel position. FIG. 9 is a diagram illustrating an output waveform of a scan signal with respect to an A point relatively close to and a B point relatively far away from an input position of the scan signal.

Referring to FIGS. 8 and 9, RC delay may be small at an A point relatively close to an input position of a scan signal, and RC delay may be large at a B point relatively far away from the input position of the scan signal.

The RC delay of the scan signal may change an off change timing of the scan signal applied to the same pixel row. As the RC delay of the scan signal increases, the off change timing of the scan signal may be later. The B point may be Δt later than the A point in the off change timing of the scan signal.

As described above, when off change timings of the scan signal are changed for each scan mode and panel position, a level of a ripple voltage added to an initialization voltage VpreR may also vary, and thus, a color and luminance characteristic of a display image may be distorted.

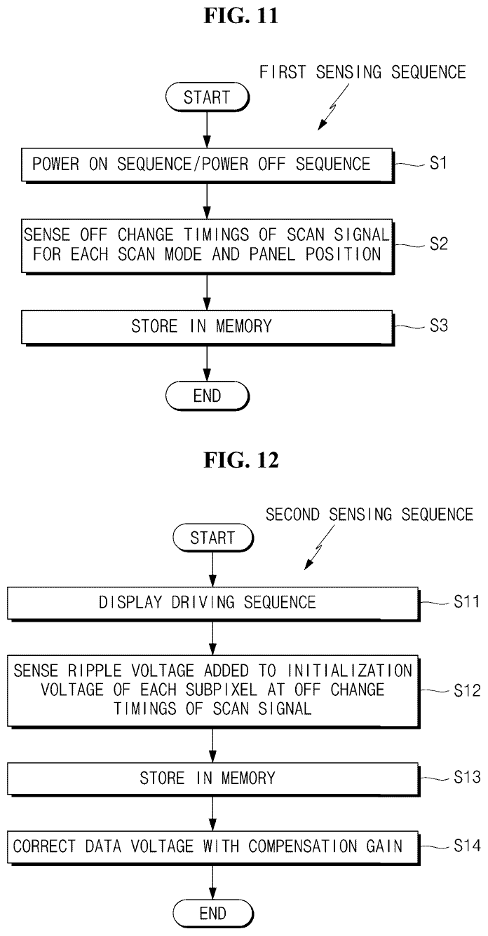

FIG. 10 is a diagram illustrating a connection configuration between a sensing circuit, correction circuit, and a memory according to an embodiment of the present disclosure. FIG. 11 is a diagram illustrating an operation sequence of a first sensing sequence for sensing off change timings of a scan signal for each scan mode and panel position. FIG. 12 is a diagram illustrating an operation sequence of a second sensing sequence for sensing a ripple voltage added to an initialization voltage of each subpixel at off change timings of a scan signal.

Referring to FIG. 11, a sensing circuit SU may perform a first sensing sequence which senses off change timings OST of a scan signal for each scan mode and panel position in a power on sequence or a power off sequence in steps S1 and S2. The power on sequence may be a pre-driving sequence until before display driving starts from immediately after a system power (alternating current (AC) power) is applied. The power off sequence may be a post-driving sequence until before the system power is released from immediately after the display driving ends.

The sensing circuit SU may individually sense the off change timings of the scan signal varying for each scan mode and panel position with respect to all scan modes and all subpixels.

The sensing circuit SU may store sensing values (i.e., sensing values of the off change timings OST of the scan signal) obtained through the first sensing sequence in a memory MEM in step S3.

Referring to FIG. 12, the sensing circuit SU may perform a second sensing sequence which senses a ripple voltage RV added to an initialization voltage of each subpixel at off change timings OST of a scan signal stored in the memory MEM during a display driving sequence in steps S11 and S12. The display driving sequence may be disposed between a power on sequence and a power off sequence and may be for display driving.

The sensing circuit SU may store sensing values (i.e., sensing values RV of the ripple voltage added to the initialization voltage of each subpixel) obtained through the second sensing sequence in the memory MEM in step S13.

Referring to FIGS. 10 and 12, a correction circuit CPC may read a compensation gain Gain corresponding to the ripple voltage RV in a predetermined lookup table. The correction circuit CPC may correct a data voltage Vdata which is to be input to each subpixel, based on a compensation gain Gain for compensating for a luminance variation caused by the ripple voltage in step S14.

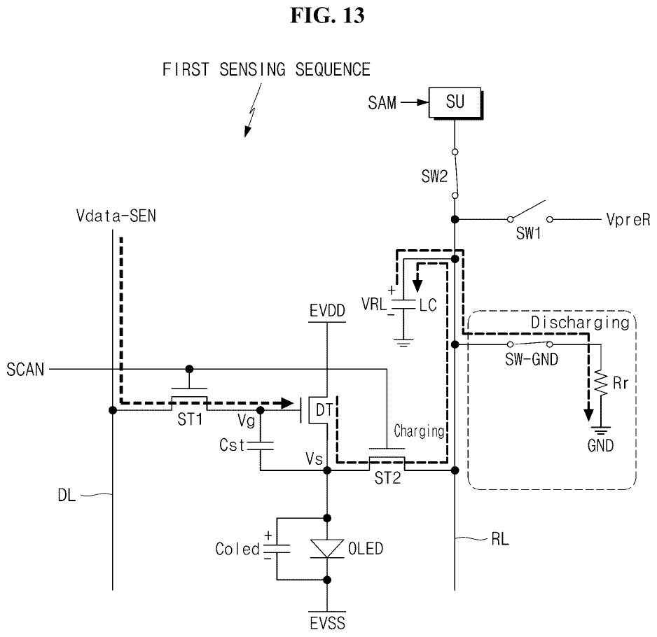

FIGS. 13 to 15 are diagrams for describing operations of a subpixel and a sensing circuit in a first sensing sequence.

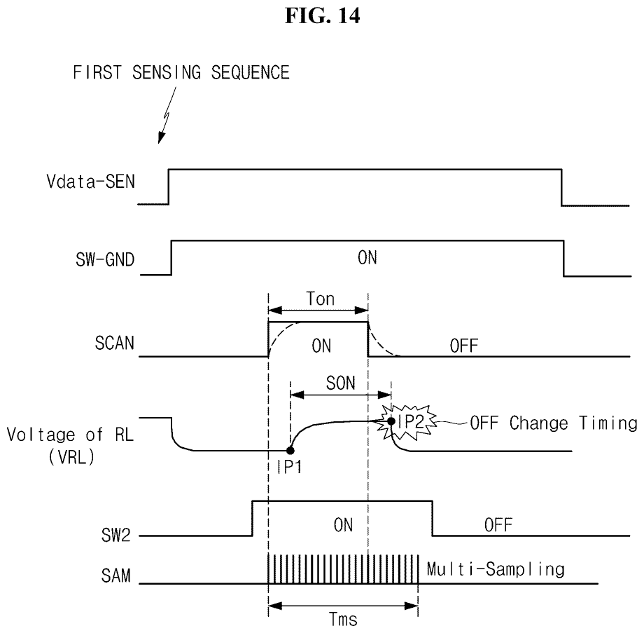

Referring to FIGS. 13 and 14, for the first sensing sequence, a reference voltage line RL connected to a subpixel may be connected to a ground voltage GND which is lower than an initialization voltage VpreR through a ground switch SW-GND. The ground switch SW-GND may maintain an on state in only the first sensing sequence and may be turned off in a second sensing sequence. The initialization voltage VpreR may be about 2 V to 5 V, and the ground voltage GND may be 0 V. The ground switch SW-GND may be disposed in a source driver.

In the first sensing sequence, a driving current corresponding to a sensing data voltage Vdata-SEN may flow through a driving transistor DT of a subpixel. A Vgs setting operation for generating the driving current may be performed in an on period Ton of a scan signal SCAN.

Due to an RC delay deviation caused by a panel position, because direct sensing on the on period Ton of the scan signal SCAN is impossible, the sensing circuit SU may multi-sample a line voltage VRL stored in a line capacitor LC of the reference voltage line RL during a multi-sampling period Tms.

The line voltage VRL of the line capacitor LC may increase from a first inflection point IP1 corresponding to an on change timing of the scan signal SCAN applied to a subpixel, based on the application of the driving current. When the driving current is discharged to the ground voltage GND, a voltage applied to a connection resistor Rr may be the line voltage VRL of the line capacitor LC. Since the driving current is cut off, the line voltage VRL may decrease from a second inflection point IP2 corresponding to an off change timing of the scan signal SCAN applied to the subpixel and be discharged to the ground voltage GND. In other words, the line voltage VRL of the line capacitor LC may have an inflection period SON between the first inflection point IP1 and the second inflection point IP2, based on the on period Ton of the scan signal SCAN. Due to RC delay, a temporal position of the inflection period SON may be later than the on period Ton of the scan signal SCAN.

The sensing circuit SU may multi-sample the line voltage VRL of the line capacitor LC during the first sensing sequence to sense the second inflection point IP2 as the off change timing of the scan signal SCAN applied to the subpixel.

For accurate sensing on the second inflection point IP2, a multi-sampling period Tms where a multi-sampling operation is performed may be set to be greater than the on period Ton of the scan signal SCAN and overlap all of the on period Ton of the scan signal SCAN.

Such a first sensing sequence may be independently performed by units of subpixel.

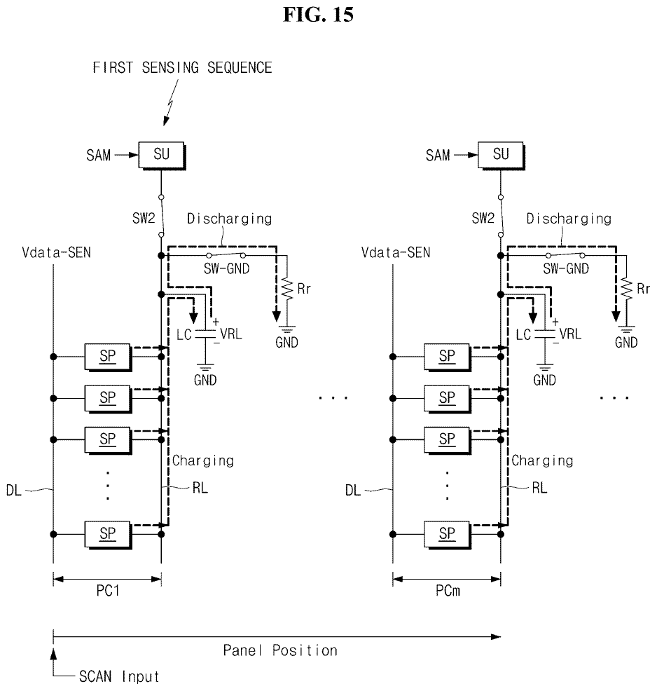

As a variation range of the line voltage VRL of the line capacitor LC in the inflection period SON increases, it may be easy for the sensing circuit SU to sense the second inflection point IP2, and thus, to this end, the first sensing sequence may be independently performed by units of pixel column as in FIG. 15. In FIG. 15, considering an input position of a scan signal SCAN, a scan signal SCAN having an RC delay of a first magnitude may be input to subpixels SP disposed in a first pixel column PC1, and a scan signal SCAN having an RC delay of a second magnitude which is greater than the first magnitude may be input to subpixels SP disposed in an m^{th} (where m may be a natural number) pixel column PCm. In subpixels SP included in the same pixel column, off change timings of the scan signal SCAN may be almost equal to one another, and thus, the first sensing sequence may be independently performed through different sensing circuits SU by units of pixel column.

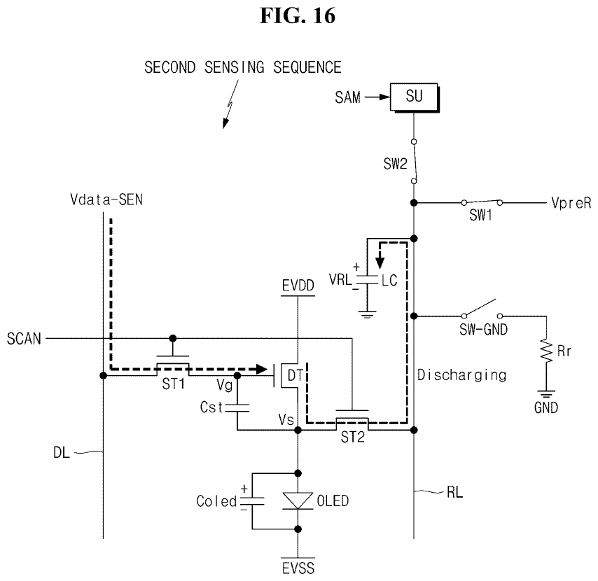

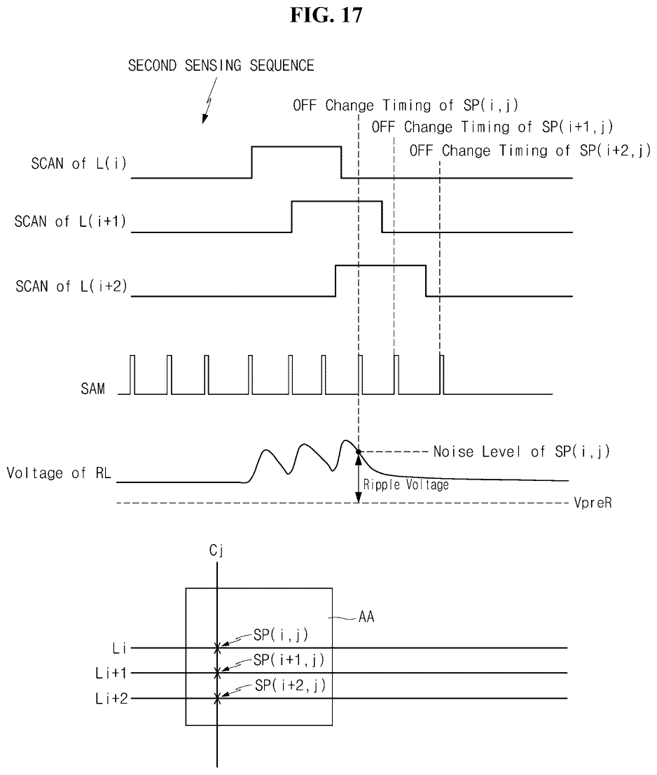

FIGS. 16 and 17 are diagrams for describing operations of a subpixel and a sensing circuit in a second sensing sequence.

Referring to FIGS. 16 and 17, for a second sensing sequence, a reference voltage line RL connected to a subpixel may be connected to an initialization voltage VpreR through a first switch SW1. A ground switch SW-GND may be turned off, and thus, a connection between the reference voltage line RL and the ground voltage GND may be disconnected.

In the second sensing sequence, a driving current corresponding to a data voltage Vdata for display driving may flow through a driving transistor DT of the subpixel. The driving current may be discharged to the reference voltage line RL, and thus, a line voltage VRL may be stored in a line capacitor LC.

The line voltage VRL stored in the line capacitor LC may include a ripple voltage which is added to the initialization voltage VpreR at an off change timing of a scan signal SCAN based on scan overlap driving.

The sensing circuit SU may sample the line voltage VRL stored in the line capacitor LC during the second sensing sequence, and thus, may sense the ripple voltage added to the initialization voltage VpreR.

The sensing circuit SU may sample the line voltage VRL stored in the line capacitor LC at an off change timing of a scan signal SCAN applied to an ith pixel row Li to sense a ripple voltage corresponding to a subpixel SP(i,j).

The sensing circuit SU may sample the line voltage VRL stored in the line capacitor LC at an off change timing of a scan signal SCAN applied to an i^{th}+1 pixel row Li+1 to sense a ripple voltage corresponding to a subpixel SP(i+1,j).

Likewise, the sensing circuit SU may sample the line voltage VRL stored in the line capacitor LC at an off change timing of a scan signal SCAN applied to an i^{th}+2 pixel row Li+2 to sense a ripple voltage corresponding to a subpixel SP(i+2,j).

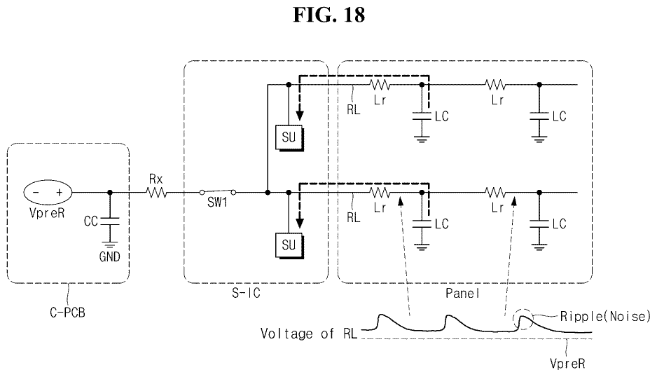

FIG. 18 is a diagram for describing the principle that a ripple voltage added to an initialization voltage may be sensed in display driving.

Referring to FIG. 18, a power source which supplies an initialization voltage VpreR may be disposed in a control printed circuit board C-PCB, and a first switch SW1 may be disposed in a source drive IC S-IC. A sensing circuit SU may be further mounted in the source drive IC S-IC.

The sensing circuit SU may be disposed closer to a display panel than the power source for the initialization voltage VpreR. Therefore, in a case where a connection resistor Rx between the control printed circuit board C-PCB and the source drive IC S-IC is sufficiently large, when a line voltage stored in a line capacitor LC of a reference voltage line RL is sampled in an on state of the first switch SW1, a ripple voltage caused by scan overlap driving may be sensed. In FIG. 18, Lr may refer to a line resistor of the reference voltage line RL, and CC may refer to a decoupling capacitor disposed in the control printed circuit board C-PCB. The decoupling capacitor CC may be omitted in the control printed circuit board C-PCB.

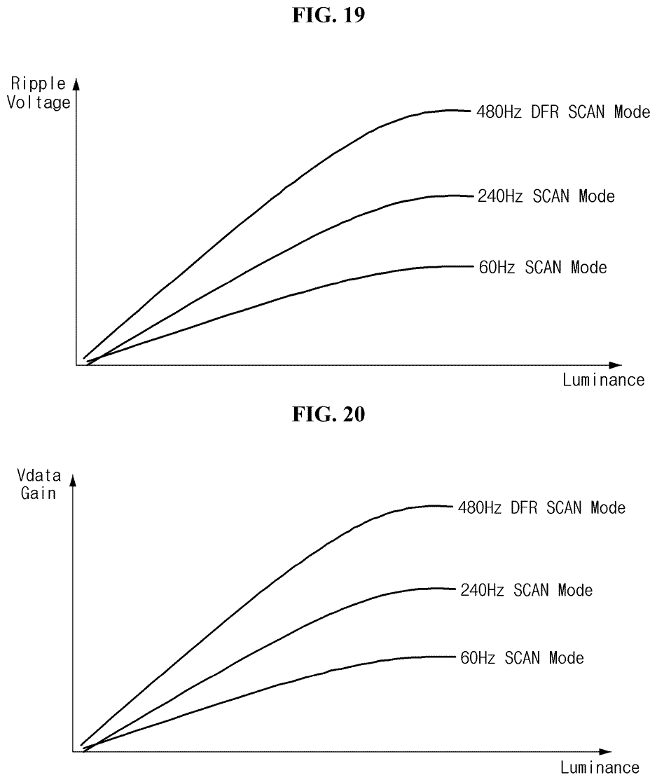

FIG. 19 is a diagram illustrating a level of a ripple voltage with respect to luminance and each scan mode. FIG. 20 is a diagram illustrating a magnitude of a compensation gain with respect to luminance and each scan mode.

Referring to FIG. 19, in each of a 60 Hz scan mode, a 240 Hz scan mode, and a 480 Hz DFR scan mode, as a luminance of a display image increases, a level of a sensed ripple voltage may increase.

In the same luminance, a level of a ripple voltage may increase progressively toward the 60 Hz scan mode, the 240 Hz scan mode, and the 480 Hz DFR scan mode.

Referring to FIG. 20, in each of the 60 Hz scan mode, the 240 Hz scan mode, and the 480 Hz DFR scan mode, as a luminance of a display image increases, a compensation gain for compensating for a luminance variation based on a ripple voltage may increase.

In the same luminance, a magnitude of the compensation gain may increase progressively toward the 60 Hz scan mode, the 240 Hz scan mode, and the 480 Hz DFR scan mode.

The embodiments of the present disclosure may realize the following effects.

The present disclosure may sense off change timings of a scan signal for each scan mode and panel position, based on a first sensing sequence, and may sense a ripple voltage added to an initialization voltage of each subpixel at the off change timings of the scan signal during a second sensing sequence in display driving. Also, the present disclosure may correct a data voltage with a compensation gain corresponding to the ripple voltage to compensate for a luminance variation caused by the ripple voltage.

As described above, the present disclosure may compensate for a panel position-based luminance deviation occurring at different levels for each scan mode, and thus, may enhance display quality.

The effects according to the present disclosure are not limited to the above examples, and other various effects may be included in the specification.

While the present disclosure has been particularly shown and described with reference to example embodiments thereof, it will be understood by those of ordinary skill in the art that various changes in form and details may be made therein without departing from the spirit and scope of the present disclosure as defined by the following claims.

What is claimed is:

1. An organic light emitting display apparatus, comprising:
a display panel including a plurality of subpixels, the plurality of subpixels configured to be scanned based on a scan signal of one scan mode among a plurality of frequency variable scan modes;
a sensing circuit configured to sense off change timings of a scan signal for each scan mode and panel position in a first sensing sequence and sense a ripple voltage added to an initialization voltage of each of the plurality of subpixels at the off change timings of the scan signal during a second sensing sequence independent of the first sensing sequence; and
a correction circuit configured to correct a data voltage which is to be input to each subpixel, based on a compensation gain for compensating for a luminance variation caused by the ripple voltage.

2. The organic light emitting display apparatus of claim 1, wherein the first sensing sequence is performed in a power on sequence or a power off sequence, and
wherein the second sensing sequence is performed in a display driving sequence between the power on sequence and the power off sequence.

3. The organic light emitting display apparatus of claim 1, wherein, in the first sensing sequence,
a driving current flows through a driving transistor of a corresponding subpixel,
a line voltage corresponding to the driving current is stored in a line capacitor of a reference voltage line,
the reference voltage line connected to the corresponding subpixel is connected to a ground voltage which is lower than the initialization voltage, and
the line voltage of the line capacitor increases based on application of the driving current from a first inflection point corresponding to an on change timing of a scan signal applied to the corresponding subpixel, and decreases from a second inflection point corresponding to an off change timing of the scan signal applied to the corresponding subpixel as the driving current is cut off and the line voltage of the line capacitor is discharged to the ground voltage.

4. The organic light emitting display apparatus of claim 3, wherein the sensing circuit multi-samples the line voltage of the line capacitor during the first sensing sequence to sense the second inflection point as the off change timing of the scan signal applied to the corresponding subpixel.

5. The organic light emitting display apparatus of claim 4, wherein a multi-sampling period of the sensing circuit is greater than an on period of the scan signal and overlaps all of the on period of the scan signal.

6. The organic light emitting display apparatus of claim 1, wherein each of the first sensing sequence and the second sensing sequence is independently performed by units of subpixel.

7. The organic light emitting display apparatus of claim 1, wherein the first sensing sequence is independently performed by units of pixel column, and the second sensing sequence is independently performed by units of subpixel.

8. The organic light emitting display apparatus of claim 1, wherein, in the second sensing sequence,
a driving current flows through a driving transistor of a corresponding subpixel,
a line voltage corresponding to the driving current is stored in a line capacitor of a reference voltage line, and
the ripple voltage is added to the line voltage of the line capacitor at off change timings of the scan signal.

9. A driving method of an organic light emitting display apparatus including a display panel including a plurality of subpixels scanned based on a scan signal of one scan mode among a plurality of frequency variable scan modes, the method comprising:
sensing off change timings of a scan signal for each scan mode and panel position in a first sensing sequence;
sensing a ripple voltage added to an initialization voltage of each of the plurality of subpixels at the off change timings of the scan signal during a second sensing sequence independent of the first sensing sequence; and
correcting a data voltage which is to be input to each subpixel, based on a compensation gain for compensating for a luminance variation caused by the ripple voltage.

10. The driving method of claim 9, wherein the first sensing sequence is performed in power on sequence or a power off sequence, and the second sensing sequence is performed in a display driving sequence between the power on sequence and the power off sequence.

11. The driving method of claim 9, wherein, in the first sensing sequence,
a driving current flows through a driving transistor of a corresponding subpixel,
a line voltage corresponding to the driving current is stored in a line capacitor of a reference voltage line,
the reference voltage line connected to the corresponding subpixel is connected to a ground voltage which is lower than the initialization voltage, and
the line voltage of the line capacitor increases based on application of the driving current from a first inflection point corresponding to an on change timing of a scan signal applied to the corresponding subpixel, and decreases from a second inflection point corresponding to an off change timing of the scan signal applied to the corresponding subpixel as the driving current is cut off and the line voltage of the line capacitor is discharged to the ground voltage.

12. The driving method of claim 11, wherein the sensing of the off change timings of the scan signal comprises multi-sampling the line voltage of the line capacitor during the first sensing sequence to sense the second inflection point as the off change timing of the scan signal applied to the corresponding subpixel.

13. The driving method of claim 12, wherein a multi-sampling period of a sensing circuit is greater than an on period of the scan signal and overlaps all of the on period of the scan signal.

14. The driving method of claim 9, wherein each of the first sensing sequence and the second sensing sequence is independently performed by units of subpixel.

15. The driving method of claim 9, wherein the first sensing sequence is independently performed by units of pixel column, and the second sensing sequence is independently performed by units of subpixel.

16. The driving method of claim 9, wherein, in the second sensing sequence,
a driving current flows through a driving transistor of a corresponding subpixel,
a line voltage corresponding to the driving current is stored in a line capacitor of a reference voltage line, and
the ripple voltage is added to the line voltage of the line capacitor at off change timings of the scan signal.
